(19) United States
(12) Patent Application Publication
(10) Pub. No.: US 2025/0344897 A1
(43) Pub. Date: Nov. 13, 2025

(54) EXTRACTION PROCESS

(71) Applicant: ACTEGA RHENANIA GMBH, Grevenbroich (DE)

(72) Inventors: Michael Lucas, Wesel (DE); Martin Bauer, Wesel (DE); Annette Tschorschke, Wesel (DE); Bjorn Askevold, Wesel (DE)

(21) Appl. No.: 18/871,200

(22) PCT Filed: Jun. 1, 2023
(86) PCT No.: PCT/EP2023/064670

§ 371 Date: Dec. 3, 2024

(30) Foreign Application Priority Data
Jun. 15, 2022 (EP) 22179163.5

(51) Int. Cl. A47J 31/06; C09D 167/00

(52) U.S. Cl. CPC A47J 31/0668; C09D 167/00

(57) ABSTRACT

The invention relates to an extraction process carried out in a container C in which at least a portion of at least one transition component is separated from a carrier by a solvent. the container C comprises a lidding foil and a body defining a receiving space which contains the carrier, the lidding foil and the body are connected to one another with a heat-sealed seam, where the heat-scaled seam contains a heat-seal lacquer provided by a coating composition comprising 55-100 wt. % of a mixture of polyester resins. wherein the wt. % is relative to the total weight of the composition and wherein at least 20 wt. % of the mixture of the polyester resins is a polyester resin A1 having a Tg higher than 50 C and at least 40 wt. % of the mixture of polyester resins is a polyester resin A2 having a Tg below 25 C.

The present invention relates to an extraction process and to the use of a container.

Solid-liquid extraction allows soluble components to be removed from solids using a solvent. Applications of this unit operation include obtaining oil from oil seeds or leaching of metal salts from ores

An everyday example is the preparation of coffee. Here, water (solvent) is used to remove the coffee flavours (being transition components) from the coffee powder (solid carrier provided by the extraction material, where the solid carrier contains the transition component). Ideally, this results in drinkable coffee (solvent with dissolved flavours), with the completely depleted coffee grounds (solid carrier phase) remaining in the coffee filter. In reality, the solid carrier will still contain some transition component after completion of the extraction. In addition, some of the solvent will still be adsorptively bonded to the solid carrier.

To achieve the fastest and most complete solid extraction possible, the solvent has to be provided with large exchange surfaces and short diffusion paths. This can be done by pulverising the solid to be extracted. However, an excessively small grain size can cause agglutination and make it more difficult for the solvent to permeate. In the simplest form of this unit operation, the extraction material and the solvent are mixed well.

Extraction is a separation process which contains the separation of at least one transition component from a carrier (a matrix). The distribution of a solute between two phases is an equilibrium condition described by partition theory. This is based on exactly how the analyte moves from the initial solvent into the extracting solvent.

Coffee brewing might be seen as to be an extraction process of daily practice. In our day very often special coffee systems or hot beverage systems are used as special coffeemaker. The extraction of coffee is carried out in a special disposable capsule-shaped-brewing-container. Each brewing container has one serving of coffee, tea, milk, and other ingredients in it. This makes it easy to make coffee, espresso, etc. The process is very clean and convenient.

In such a closed disposable brewing container the capsule body and the lidding foil (antagonist foil) are connected by means of a heat-seal lacquer which often provides also the inner coating of the capsule.

WO2015180960 concerns such a disposable beverage-brewing container comprising a body, with the beverage-forming ingredients and an antagonist foil connected to the body, by means of a heat-seal lacquer for closing it. In general, reaching higher pressures in the disposable beverage-brewing container causes a greater transport of flavors from the ingredients, intended for the formation of the beverage, into the injected liquid and therefore a beverage of higher quality. However, these higher pressures may cause a leakage or rupture at the level of the seal between the body and the antagonist foil and thus do not allow an optimal retaining of the liquid inside the container. Consequently, on the one hand the used heat-seal system must provide a stable closing of the beverage container. However, on the other hand said heat-seal system should not be environmental problematical or critical concerning food-safety. Unfortunately, this is often difficult to combine with the needed strong closing properties because the typically used heat seal lacquers normally need (in order to perform well) such critical components, like polyvinylchloride.

Additionally, it should be taken into consideration that there is a high price pressure in the relevant market so that expensive solutions are not compatible.

Thus, the object of the invention is to present an economical technical solution for providing an extraction process which might be the basis of a convenient hot beverage system. It is important that said extraction process might be carried out at high pressures so that e. g. a used extraction container has to be fluid-tight and to be able to withstand high pressure. The beverage system should not need (and preferably should not contain) food-safe-critical or environmental problematical components like polyvinylchloride in order to withstand said high pressures.

The solution to this problem is an extraction process carried out in a container C in which at least a portion (preferably a least 20, more preferably at least 60 wt. %) of at least one transition component is separated from a carrier by a solvent,

the container C comprises a lidding foil and a body defining a receiving space which contains the carrier, the lidding foil and the body are connected to one another with a heat-sealed seam, where

the heat-sealed seam contains a heat-seal lacquer provided by a coating composition comprising 55-100 wt. % of a mixture of polyester resins,

wherein the wt. % is relative to the total weight of the composition and wherein

at least 20 wt. % of the mixture of the polyester resins is a polyester resin A1 having a Tg higher than 50° C. and

at least 40 wt. % of the mixture of polyester resins is a polyester resin A2 having a Tg below 25° C.;

the glass transition temperature (Tg) is measured using differential scanning calorimetry (DSC) according to a modified DIN ISO 11357 (ISO 11357-2:2020); the only relevant modification is that the Tg values were measured using a heating rate of 10 K/min—instead of 20 K/min (which would be according to the non-modified DIN).

Relevant transition components are typically soluble in the solvent. Normally, more than (only) one transition component is separated from the carrier (e. g. in the case of coffee extraction).

The coating composition above refers to the already processed system (typically the already dried/solvent free) coating composition. The non-processed pre product of the coating composition typically (additionally) also contains a high amount of solvents (typically provided by a solvent borne coating—see below).

Per definition the polyester resin (each macromolecule) contains at least two ester groups.

The polyester resin A1 might be provided by only one species or type. Alternatively, A1 might be provided by more than one species or type so that it is provided a mixture of different polyester resins having a Tg higher than 50° C. Also A2 might be provided by only one species or type or alternatively by a corresponding polyester resin mixture.

The glass transition temperature of a material (Tg) is measured using differential scanning calorimetry (DSC) according to a modified DIN ISO 11357 (ISO 11357-2:2020). However, there is one modification concerning said DIN which is used according to the present invention: In the relevant measurement the enthalpy change when heating or cooling a sample is measured. The results of this measurement can be used to determine Tg. This procedure is well known to the skilled person. Modification according to the present invention: the Tg values mentioned in this document (according to the definitions of the present invention) were measured using a heating rate of 10 K/min (instead of 20 K/min, which would be according to the relevant (original) DIN).

The coating composition generally shows a good adhesion when applied onto a substrate. Thus, the coating composition is not only appropriate as a heat seal-lacquer but additionally provides also an excellent coating with good mechanical properties which is especially relevant in connection with the fact that the relevant coated material has to be stressed by a drawing/shaping process (after the coating is applied and dried). Due to the simplification of the production process is an economical advantage if the coating composition might be usable for both: as the heat-seal lacquer and as the coating being in direct food-contact. Additionally, the coating composition might be also used for the outer coating (coating for the other side of the substrate foil).

Also the properties as heat-seal lacquer are very well. E.g. a stable closing of a beverage container might be achieved so that especially higher pressures in the container would not cause a leakage or rupture at the level of the produced seal.

The high resistance to chemical stress at elevated temperatures, which is relevant for the food sector (especially in extraction processes), is an essential quality feature of the (dried) heat seal lacquer. Especially, the said resistance can be determined by “boiling ethanol” which is in contact with the lacquer and subsequent visual inspection of the stressed lacquer (see below).

Furthermore, the heat seal lacquer allows (enables) an economical and industrially practical (economical) manufact process/processing of the container C.

The use of the mixture of polyester resins (with said different Tg values) provides the advantage that the behaviour of sealing-& deepdrawing performance (mechanical properties) as well as substrate-and foodstuff protection (health question) are well balanced (at the same time working well).

The use of said mixture (as defined: polyester resins with said different Tg values) especially ensures that the relevant heat-sealing film (coating) remains undamaged during the mechanical shaping (e.g. deep drawing of the corresponding coated substrate). Otherwise irregularities in the paintwork, such as micro-cracks, typically occur. This normally leads to the generation of leaks within the heat-seal seam. Thus, the use of said mixture especially ensures the provision of a mechanically durable (robust and uniform) heat-seal seam which guarantees a reliable closure.

The coating composition generally contains only food safe and environmentally non-critical ingredients: All ingredients should be safe for direct food contact. This means that such ingredients should be compliant with or described in EU No 10/2011 or US 21 CFR 174-21 CFR 190. In particular, the coating compositions should be FDA-compliant according to 21 CFR 175.300 or 21 CFR 178.3297.

In a preferred embodiment of the invention after the separation from the carrier at least a portion of the at least one transition component is discharged from the closed container by means of the solvent.

Normally, at least a portion (preferably at least 60 wt. %) of the carrier is retained in the container C, which is preferably accomplished by means of filtration.

Typically, the solvent is introduced into and discharged from the container C at the same time (being a continuous process). This is normally practiced in the continuous brewing process in a coffee capsule.

Preferably, at least a portion of the carrier is provided by a solid phase carrier and at least a portion of the solvent is provided by a water containing solvent (or dispersion), preferably by drinking water.

Normally, the extraction process is carried out at an overpressure in the container C of 2-100, preferably 6-30 bar. Typically, the extraction process is carried out at a temperature in the container C of 40-120, preferably 60-100° C. These are the typical extraction conditions in a coffee capsule. Very often the carrier contains or consists of coffee. However, the carrier might contain or consists of tea.

The use of capsules is very consumer friendly and easy to perform. No technical knowledge is required to use capsule machines. The machine is easy to use, and a cup of coffee can be prepared within about 30 seconds. After the brewing process, it is very easy to clean the machine, as you only need to remove the capsule. Compared to the normal espresso machines, a capsule machine is much cheaper.

The extraction process according to the invention (in particular brewing process) is further associated with the following advantages: low pollution, protection of the aroma, long shelf life and preservation of the flavorings (coffee powder, for example, can be stored in the capsule for over a year without noticeable loss of quality).

According to a preferred embodiment it is realized that at least 25 wt. % of the mixture of the polyester resins is represented by a polyester resin A1 having a Tg higher than 50° C. and at least 55 wt. % of the mixture of the polyester resins is represented by a polyester resin A2 having a Tg below 25° C.

According to a special embodiment of the invention it is realized that

at least 60 wt. % (preferably 100 wt. %) of the polyester resin A1 (of the species of A1) has a Tg of 57-95° C. and at least 60 wt. % (preferably 100 wt. %) of the polyester resin A2 (of the species of A2) has a TG of 2-24° C.

The use of (too much) polyester resin having a TG below 2° C. typically has the disadvantage that the processability of the coated substrate is significantly decreased (e.g. by “blocking” the used coatings reel so that unwinding is more difficult, or e.g. worse with regard to mobility in the stamping press) which would have negative effects concerning quality and/or economy.

Polyester species having a relative small amount of (terminal) carboxyl groups are generally beneficial regarding to the water resistance. Preferably, 90 wt. % of the polyester resin A1 has an acid value of <10 mg KOH/g (according to DIN EN ISO 2114) and a hydroxyl value of 2-20 mg KOH/g (according to DIN EN ISO 4629-2). Typically, 90 wt. % of the polyester resin A2 has an acid value of <15 mg KOH/g and a hydroxyl value of <15 mg KOH/g.

Appropriate polyester resins used in the composition are generally food compatible and environmentally friendly.

Typically monomers (based structural units) of the polyesters (type A1 and A2 both) are e. g. neopentyl glycol, ethylene glycol, isophthalic acid, terephthalic acid and sebacic acid.

Additionally, the following monomers (as corresponding structural units) might be contained:

As poly acids: adipic, 1,4-cyclohexanedicarboxylic (CAS Reg. No. 1076-97-7), dimerized fatty acids, fumaric acid, isophthalic acid, maleic acid, 2,6-naphthalenedicarboxylic acid, orthophthalic acid, suberic acid, sebacic acid, terephthalic acid, terpene-maleic acid adducts.

As mono acids: benzoic acid, 4,4-bis (4′-hydroxyphenyl)-pentanoic acid, tert-butyl benzoic acid, fatty acids.

As polyhydric alcohols: butylene glycol, diethylene glycol, 2,2-dimethyl-1,3-propanediol (NPG), ethylene glycol, glycerol, mannitol, methyl glucoside, pentaerythritol, propylene glycol, sorbitol, triethylene glycol, trimethylolethane, trimethylolpropane.

As monohydric alcohols: cetyl alcohol, decyl alcohol, lauryl alcohol, myristyl alcohol, octyl alcohol, stearyl alcohol.

Commercially available types of polyesters of the type A1 (all having a Tg above 60° C.) are e.g.: Dynapol L 205 (Evonik), Skybon ES 120 (SK Chemicals), Skybon ES 100 (SK Chemicals), Marnex AH651 (Macroocean), Vitel 2100B (Bostik) and Vylon 200 (Toyobo) Type 5011 (Eternal) and Vylon GK 255 (Toyobo).

Commercially available types of polyesters of the type A2 (all having a Tg below 18° C.) are e.g.: Vylon 560 (Toyobo), Skybon ES 220 (SK Chemicals) and Vylon 670 (Toyobo).

Typical average molecular weights (Mw) of the polyester types A1 and A2 are about 10.000-100.000 (generally the weight average of the molecular weight Mw is meant).

According to a typical embodiment the composition further comprises a mineral filler and/or a wax (especially because to support the processability).

Preferably the (dried) coating composition contains less than 4.0 wt. %, preferably less than 0.8 wt. %, more preferably no, crosslinking resin.

Crosslinking resins according to the present invention have reactive functional groups, provided by hydroxyl -and/or amino groups, that are able to react with carboxyl groups and/or ester groups (e.g. by transesterification) of the contained polyester resins.

Typically used crosslinking resins are of the “amino-(form) aldehyde-type” which are well known by the skilled person. Generally, the (appropriate) crosslinking resins are selected from the group consisting of urea-formaldehyde resins, melamine-formaldehyde resins, benzoguanamine-formaldehyde resins and glycoluril-formaldehyde resins.

Preferably the (dried) coating composition contains less than 4.0 wt. %, preferably less than 0.8 wt. %, more preferably no, crosslinking resin selected from the group consisting of urea-formaldehyde resins, melamine-formaldehyde resins, benzoguanamine-formaldehyde resins and glycoluril-formaldehyde resins.

For example (preferably only limited amounts of) a benzoguanamine-formaldehyde resin might be used (available as “Komelol BG resins”—n-butylated benzoguanamine formaldehyde resin or “Cymel® benzoguanamine resins”). In case a (preferably only a limited proportion of) crosslinking resin is used normally also a curing catalyst is needed. Preferably, the curing catalyst comprises a sulfonic acid containing compound. According to a typical example said catalyst is represented by a dodecylbenzene sulfonic acid compound. Sulfonic acid containing compounds that can be used as catalyst in the composition of the current invention are commercially available and include Sulfonax® (ex Kao Chemicals) and Nacure 5076 (ex King Industries).

A high amount (e.g. a proportion of 4 wt. % or more) of crosslinking resins typically deteriorates the (mechanical) heat-sealing values (results) so that e.g. the seal strength of the heat-sealed seam would be reduced. Thus, it is often advantageous to avoid the use of any crosslinking resin. However, in special cases (especially depending on the kind (chemistry) of the used polyester resins and their proportion in the composition) a small amount of crosslinker might provide a positive impact on coatings inner cohesion. Thus, the provision of small amount of crosslinker does not necessarily mean a negative influence concerning mechanical properties (e. g. as according to example 3 of the experimental part-below). However, also in said special cases the (dried) coating composition should preferably contain less than 4.0 wt. % crosslinker.

Consequently, the proportion of crosslinking resin is preferably limited in such a way that the heat-sealed seam provides a sealing-seam strength of more than 12 N/15 mm, preferably of more than 16 N/15 mm (according to a modified DIN 55529, 2012 edition—modifications: trigger angle is 180°, testing speed is 200 mm/min). This is according to the quality requirements on which the invention is especially based: the heat-sealed seam should be especially suitable for sufficiently closing a “coffee capsule” (typically provided as a portion pack brewing container).

According to a preferred embodiment of the present invention the heat-sealed seam provides a sealing-seam strength of more than 12 N/15 mm, preferably of more than 16 N/15 mm (according to a modified DIN 55529, 2012 edition—modifications: trigger angle is 180°, testing speed is 200 mm/min).

As fillers inorganic fillers with or without surface treatment might be used, like chalk, talcum and pyrogen or colloidal silicic acid. These components need not be used as primary particles but might be also provided as agglomerates in the binder matrix.

The corresponding wax types used might be polyethylene based or polypropylene based or from natural origin. Commercially available types are especially:

“Carnauba-”, “PTFE-”, “Fischer-Tropsch-”, “Montan-”, “polypropylene-” wax and blends of them.

The wax might be added as a solid or in a dispersed form.

However, according to a preferred embodiment the coating composition comprises 75-100 wt. %, preferably 90-100 wt. %, of the mixture of polyester resins (of relevant polyester resin species).

According to a preferred embodiment the coating composition contains less than 1 wt. % (in the composition in which the solvents are already removed), more preferably no, polyvinylchloride. According to the present invention it is not necessary to use polyvinylchloride as a component of the coating composition because the requested performance is achievable without polyvinylchloride.

It is generally advantageous to avoid polyvinylchloride because it is environmentally critical. Especially dioxine forming during thermal waste treatment is observed. Additionally, externally plasticized PVC-Polymers are under authority investigation due to plasticizer migration into food material

Preferably, the lidding foil and the body defining a receiving space are each provided by a metal or a metal alloy, preferably on the basis of aluminum (typically aluminum only).

Other materials might be plastic films (polymer based) or laminates of “plastics-and aluminum”.

The body defining a receiving space has typically a cup-like shape (“volume of the cup as the receiving space”) like the body of a commercially available coffee capsule. Typically, the body has a flange extending from its jacket wall, where the heat-sealed seam lies on said flange. This enlarges the heat-sealing surface (relevant contact surface with lidding foil).

Normally, the inner surface of the body is completely coated with the heat-seal lacquer. This increases the economy of the corresponding technology because the processing is simplified.

Furthermore, the coating (and also the heat-sealed seam) acts as an off taste-barrier, preventing filling goods from aluminum taste. Additionally, the coating layer (and also the “pre-heat-sealed seam”) supports the surface mobility during the deep drawing process.

Typically, the (dried) relevant heat-seal lacquer coating has a thickness of 6-17 g/m².

Normally, both sides to be heat-sealed with each other are coated (lidding foil and body). The (outer side—not to be heat-sealed) might be also coated with a different, e.g. non-polyester based coating type.

Typically, a substrate foil is shaped as a container which inner surface is completely coated with the heat-seal lacquer, where said heat-seal lacquer coating preferably has a thickness of 6-17 g/m² (thickness of the dried layer in which the solvents are already removed).

Such corresponding container body typically comprises the heat-seal lacquer not only at the relevant seal area but also as the inner coating of the capsule. The structure to be heat-sealed further comprises the lidding foil (as an antagonist foil, typically aluminum based) which is (normally) also (pre) coated with (the) heat-seal lacquer—prior the heat-sealing. The lidding foil is often shaped (e.g.

embossed) before sealing for promotional purpose or in order to increase its mechanical stability.

A relevant substrate foil for the body might be aluminum based (e.g.: 80-100 μm AI8011) and the lidding foil also aluminum based (e.g.: 38 μm AI9901).

Preferably, the substrate foil for the body and the lidding foil are coated with the same heat-seal lacquer.

The typical method for manufacturing such a (closed) container as described above (used as the container C) has the following steps: providing a lidding foil and a body defining a receiving space, introducing the carrier (as the filling material) into the receiving space and closing the container by heat-sealing, where the body is generated as a blank which before the introducing of the filling material had been formed in its geometry, where

the generation of the blank includes the following steps:

step 1: at least a partial area of a provided substrate foil is coated with a solvent borne coating comprising the ingredients of the (dried) heat-seal lacquer and

step 2: the thus coated substrate foil is heated to a peak metal temperature (PMT) of at most 120° C. so that the solvent is removed.

“Peak metal temperature” (PMT) refers to a temperature of the relevant substrate, in the current patent application to the temperature of the substrate which is normally provided by a metal or metal alloy foil. In general, the peak metal temperature is lower than the temperature of the oven that is used to heat the metal and depends, i.e., on the residence time in the oven.

The used solvents typically have a boiling point of 50-110° C. (atmospheric pressure boiling point) and are suitable solvents for polyester resins (especially for the types A1 and A2). Said solvents might be provided by a single solvent or by species of a solvent mixture.

Particular good results were found in the process described above when the solvent is 2-Butanon (methyl ethyl ketone) (boiling point 80° C.) and/or ethyl acetate (boiling point 77° C.) or a mixture of solvents comprising 2-Butanon (methyl ethyl ketone) and/or ethyl acetate. The use of 2-Butanon (methyl ethyl ketone) and or ethyl acetate as a solvent or a mixture containing at least one of these solvents is in particular beneficial to provide for compositions that can be tack free at a peak metal temperature of at most 100° C. Other solvents (especially with higher boiling points) that can be present in a mixture with 2-Butanon (methyl ethyl ketone) and/or n-propyl acetate (methyl ethyl acetate) include n-butanol (boiling point 118° C.). The presence of such higher boiling point solvents might improve the levelling of the wet coating prior drying.

Normally, it is preferred that the substrate foil is coated with such a solvent borne coating comprising the ingredients of the heat-seal lacquer. In principle, however, it is at least possible to dispense with the use of solvents and to provide the ingredients of the heat-seal lacquer by means of a melt (typically by using an extruder).

Step 2 allows a mechanical pretreatment especially a coiling without damaging the (pre) coated substrate. The peak metal temperature in step 2 should be high enough to obtain a tack-free coated substrate and at the same time should be low enough to enable step 1 to be done in the same environment (e.g. in a printing machine).

“Tack-free” in relation to a substrate means that the substrate is in a sufficiently robust state to resist damage by contact or handling and/or concerning the settling of dirt and/or concerning sticking to the backside in the coil. To test the tack-free time, the time can be determined by briefly pressing a polyethylene film against the surface of the substrate and to check for any adhering material when the film is removed. In such test a small weight can be used to provide a reproducible contact pressure.

Typically, after step 2 but also after step 3 the substrate might be cooled and rolled (as a coil). A coil is an attractive and economic possibility to handle and to transport the relevant substrate which is a pre-product that has to be further processed (typically at a different location).

To allow for the rolling of the coated substrate and unrolling in a next processing step without any detriment to the coating layer (providing a block-free coil), such substrate should have a low tack or be tack free. The (only dried but not cured) heat-seal lacquer which is provided according to the present invention shows such sufficient low tack or tack free properties: for such rolling it is not in every case necessary for the coating layer to be fully cured and hardened (which makes the preparation process more economical), but it was found that it is sufficient for the coated substrate to have a low tack or be tack-free, such that any adhesion between the subsequent layers in a roll is so low that no damage is caused to the coating layer by the rolling or unrolling of the coated foil.

Rolling the substrate can be advantageous in particular in an embodiment where at least step 1 and step 2 are performed in a printing apparatus and the further processing of the coated substrate includes the mechanical processing of the coated substrate, for example when it is divided in smaller pieces of a coated foil and/or when the coated foil is formed, for example, in a deep drawing process.

Preferably, in a step 3 (after step 2) the coated substrate foil is further treated by coiling and thereafter in a step 4, preferably after unwinding, mechanically shaped by generating the body defining the receiving space.

Step 1 and step 2 might be performed in a printing apparatus or in a coil coating line. This simplifies the corresponding processing and provides a significant economical advantage.

In many cases (before step 4) in a step 3a the coated substrate is lubricated with natural or synthetic lubricant.

In special embodiments, before the shaping step the coated substrate is additionally heated (cured). However, in most cases such an additional thermal curing is not necessary in order to provide a coating which has a high flexibility/mechanical stability. Consequently, the coating might be subjected to various types of mechanical handling. It was found that such coated substrate is in particular suited for embossing or deep drawing of the coated substrate (in order to form the body defining the receiving space), since the coating layer on the substrate shows a high flexibility and a good adhesion.

Typically, in step 4 the coated substrate is shaped into the form of a portion pack brewing container (used as the container C). This preferably done by deep drawing or embossing.

Generally, the portion pack brewing container shape (as the receiving space of the body) is filled with extraction material (the carrier) so that the extraction material is in direct contact with the heat-seal lacquer and thereafter in the sealing step the heat-seal lacquer is activated accordingly by elevated temperature and increased pressure.

Finally, the present invention is also directed to the use of a container C as described above as a beverage-brewing container.

Below the present invention is described in more detail by using examples.

In the examples the compositions of the lacquer (solvent borne) and the corresponding dried lacquer film (solvents removed) are provided by the corresponding wt. % values.

| | | | | | | | Examples | |
|---|---|---|---|---|---|---|---|---|
| | | | Example 2 | | | | 4 and 5 | |
| | Example 1 | | | dried | Example 3 | | Ex. 4 | Ex. 5 |
| | lacquer | dried | lacquer | film | lacquer | dried | lacquer | lacquer |
| Polyester X (type A2) | 22.1 | 65.38 | 21.6 | 61.54 | 20.4 | 52.47 | 29.9 | |
| [Tg: 15° C.] | | | | | | | | |
| Ethyl acetate | 46.6 | | 45.5 | | 43.0 | | 69.7 | 69.7 |
| Polyester “Vylon | | | | | 9.5 | 24.43 | | 29.9 |
| 200” [Tg: >65° C.] | | | | | | | | |
| Polyester Y (type A1) | 11.3 | 33.44 | 10.1 | 28.77 | | | | |
| [Tg: 75° C.] | | | | | | | | |
| 2-Butanon (MEK) | 19.6 | | 19.2 | | 18.1 | | | |
| “Cymel 303” | | | | | 1.0 | 2.52 | | |
| “Mju wax 2000” | | | 3.2 | 8.55 | 3.0 | 7.72 | | |
| “Hakuenka CCR-S” | | | | | 4.6 | 11.83 | | |
| “Aerosil 200” | 0.4 | 1.18 | 0.4 | 1.14 | 0.4 | 1.03 | 0.4 | 0.4 |
| | 100.0 | 100.0 | 100.0 | 100.0 | 100.0 | 100.0 | | |

polyester (type A2) X - contained monomeric structural units: NPG (2,2-dimethylpropane-1,3-diol) about 25 mol %; EG (ethylene glycol) about 25 mol %; TPA (terephthalic acid) about 30 mol %; IPA (isopthalic acid) about 5 mol %; suberic acid about 15 mol %; Tg: 15° C.; Molecular weight about 30.000, Acid Value (KOH mg/g) 2; Hydroxyl group value (KOH mg/g) <2
polyester (type A1) Y - contained monomeric structural units: NPG (2,2-dimethylpropane-1,3-diol) about 20 mol %; EG (ethylene glycol) about 30 mol %; TPA (terephthalic acid) about 25.0 mol %; IPA (isopthalic acid) about 25.0 mol %; Tg: 75° C.; Molecular weight about 21.000; Acid Value (KOH mg/g) < 3; Hydroxyl group value (KOH mg/g) = 3
polyester “Vylon 200” (type A1) Z - Tg >65° C.; Molecular weight about 17.000, Acid Value (KOH mg/g) <2; Hydroxyl group value (KOH mg/g) = 6
“Hakuenka CCR-S”: precipitated calcium carbonate
“Mju wax 2000”: micronized synthetic wax compound/Acid Value (KOH mg/g) 0 mg/Drop point 114° C./Particle size D50 about 6.5 μm/Particle size D99 about 16 μm
“Cymel 303”: highly methylated melamine crosslinker; Viscosity at 23° C. about 3000-6000 mPas
“Aerosil 200”: hydrophilic fumed silica

The composition regarding the comparative example (PVC-lacquer) contains two different PVC types (each contained in an amount of 10.5 wt. %), butyl acetate (18 wt. %), MEK (2-butanon) (51 wt. %) and PM (1-methoxy-2-propanol) (10 wt. %): Regarding the comparability with the present invention it is not possible to simply replace the polyester (the same amount of it) by polyvinylchloride (and the other parameters being constant) because this is generally not practicable (especially because of rheology problems (viscosity)—such compositions would not be usable as a coating).

The examples 1-3 are according to the present invention and examples 4 and 5 (as well as “PVC-lacquer”) are comparative examples containing not a mixture of “type A1” and “type A2”.

| | Exam- | Exam- | Exam- | Exam- | Exam- | PVC- |
|---|---|---|---|---|---|---|
| | ple 1 | ple 2 | ple 3 | ple 4 | ple 5 | lacquer |
| (Peel value) | 17.1 | 22.7 | 26.3 | 29.6 | 17.3 | 15.5 |
| Maximum sealing | | | | | | |
| strength [N/15 mm] | | | | | | |
| (Peel value) | 14.4 | 21.4 | 23.0 | 18.2 | 5.4 | 13.9 |
| Average sealing | | | | | | |
| strength [N/15 mm] | | | | | | |
| Visual assessment of | ok/ok | ok/ok | ok/ok | Slight | Completely | ok/ok |
| the dried coating after | | | | blush/ | blushed/ | |
| (20 wt. % ethanol/80 | | | | loss of | loss of | |
| wt. % water) cooking | | | | adhesion | adhesion | |
| (120 min, at about | | | | while | immediately | |
| 120° C.) | | | | scratching | after test | |
| [Blushing/Delamination] | | | | with | | |
| | | | | spatula | | |
| Block test | Ok (0) | Minimal | Ok (0) | Blocks (4) | OK (0) | Ok (0) |
| | | sticky (1) | | Sticky | | |

Why is a distinction made between “maximum” and “medium” sealing strength—the following simple explanations for the basic understanding only:

“Average” sealing strength: “measured average force along the testing distance” (“relevant concerning the peeling behavior when separating lidding foil from container”)

“Maximum” sealing strength: normally relevant at the beginning of the test (“force which is required to initially break the adhesion of lidding and body”)

### Examinations:

### Test Method: Peel Value (Sealed-seam Strength)

Especially since coffee capsules do not represent suitable mechanical test bodies due to geometric reasons—the relevant peel values were measured as follows:

The “peel value” is measured according to a modified DIN55529 (2012 edition), which is relevant concerning “determining the sealed-seam strength of sealings made of flexible packaging material”.

In this connection the two modifications (adjustments) to said DIN are fulfilled:
trigger angle is 180° (instead of 90° C. in the original DIN)
testing speed is 200 mm/min (instead of 100 mm/min in the original DIN)

Sealing is carried out according to the “Fin seal” method ASTMF88/F88M-15 on 15 mm wide test strips. The sealing surface is 10*15 mm. The sealing conditions in the laboratory are: contact time: 2 seconds, pressure: 800 N, Sealing jaw width: 10 mm, Upper sealing jaw: 240° C., lower sealing jaw: 180° C.; the specimens are prepared with a heat contact device type HSG-C of “Brugger Feinmechanik”: bottom/bottom 2″ 240° C. upper sealing jaw 180° C. lower sealing jaw 10 mm 800 N.

### Test Method: Ethanol Cooking (Stress Test)

In order to assess the migration studies for clear drinks like coffee the EU regulation No. 10/2011 Annex III dictates 20 Vol. % ethanol solution as extraction simulant. For preventing expensive migration studies, only samples without optical defects like blushing and obvious delamination are selected for these studies. A lab testing method is installed by forming a shell of plain coated substrate by bending the sides upwards, leading to an inner area of 10 cm*15 cm. The shell is filled with 35 g of ethanol solution. An ethanolic steam environment is created by filling a closable larger container (e. g. 30 | pail) with a level of 10% of exactly the same ethanol-solution. The specimen shells are stored on a rack above the liquid line. The whole container is hermetically closed and stored for 2 hours at 120° C. in an oven. After finishing the procedure, the specimen are dried with lab tissue and immediately treated by scratching the surface with a wooden spatula. The test is ok in case that no coating film can be removed from the aluminum surface. Secondly, the blushing is rated by comparing the specimen to an untreated specimen. The test is ok in case no visible blush is detected.

### Test Method: Block Test

Purpose: The test procedure of this standard is used to check the adhesive behavior of paint films under constant pressure (related to practice).

Sample: An average sample is taken from a paint material to be tested according to ISO 15112 and prepared according to ISO 1513. Samples from coated objects shall be taken or selected so that they can be considered as average samples; Preparation of the test specimen: The substrate for the trial coating shall be the material (including surface quality) for which the coating is intended, or which is specified in the terms of delivery. The substrate is prepared or pre-treated in a manner to be agreed (e.g. degreasing, pickling, phosphating, grinding). The coating material or coating system to be tested shall be applied in the usual manner and thickness or layer in accordance with the production process and dried as agreed and, if necessary, post-treated. The test samples are painted plates with length 50 mm and width 50 mm prepared as described in Sections 5.1-5.3. Three test specimens for each coating material to be tested (backside coating). The test specimens are stacked against the back between two chipboards (for even pressure distribution). The screw clamp is closed with a torque wrench with a defined force of 20 Nm. If the specification deviates from 20 Nm, this must be noted. Storage: 1 hour at 40° C. in a drying oven (standard conditions). After removal from the oven and cooling of the formats, the lacquer surface is evaluated.

Evaluation criteria: 0=OK/no gluing; 1=minimal sticky (tick); 2=slightly sticky; 3=clearly sticky (slight “picking tendency”); 4=very sticky (strong “picking tendency” or fusion)

### Example Concerning a Brewing Process (According to the Present Invention):

### Preparation of the Brewing Container:

A lacquer according to example 2 is used (for both foils). An aluminum body foil (90 um) is coated with said lacquer on the back side: coat foil (90 um) with heat seal lacquer (10+/−1 g/m²), temperature treatment 20 s 235° C. peak metal temperature (PMT) 216-224° C.; the aluminum coat lid foil (30 um) on matt side with heat seal lacquer (10+/−1 g/m²) 20 s 180° C.; PMT=160° C. Greasing the 90 μm foil, followed by deep drawing it to receive a capsule. Cutting lidding film into 34 mm circles. Filling capsules with approx. 5 g coffee powder. Sealing the capsules with 0,2 s 250° C. 5 bar.

Brewing process:

Brewing capsules with a (Krups type X/N 4006 45 s) coffee extrusion machine: The extraction process takes place at about 10 bar. For an Espresso, about 40 ml of water is used, resulting in a temperature of approximately 75° C. For a Lungo, about 105 mL are used, resulting in a temperature of approximately 82° C.

### Evaluation of the Results of the Brewing Process:

The cooled capsules remained tight. Opening capsules, in order to remove extracted coffee powder and check for any damage of the coating. The coating remains intact during the extraction process, the underlying aluminum does not come into contact with the extraction agent. The coating allows to make a coffee without negatively influencing the taste and aroma of the used coffee. There is no deterioration of the coffee taste during the brewing process or contamination with hazardous materials.

1. An extraction process carried out in a container C in which at least a portion of at least one transition component is separated from a carrier by a solvent,
the container C comprises a lidding foil and a body defining a receiving space which contains the carrier, the lidding foil and the body are connected to one another with a heat-sealed seam, where
the heat-sealed seam contains a heat-seal lacquer provided by a coating composition comprising 55-100 wt. % of a mixture of polyester resins,
wherein the wt. % is relative to the total weight of the composition and wherein
at least 20 wt. % of the mixture of the polyester resin is a polyester resin A1 having a Tg higher than 50° C. and
at least 40 wt. % of the mixture of polyester resins is a polyester resin A2 having a Tg below 25° C.;
the glass transition temperature (Tg) is measured using differential scanning calorimetry (DSC) according to a modified DIN ISO 11357 (ISO 11357-2:2020); the only relevant modification is that the Tg values were measured using a heating rate of 10 K/min—instead of 20 K/min (which would be according to the non-modified DIN).

2. The extraction process according to claim 1, where after the separation from the carrier at least a portion of the at least one transition component is discharged from the closed container by means of the solvent.

3. The extraction process according to claim 1, whereby at least a portion of the carrier is retained in the container C.

4. The extraction process according to claim 1, where the solvent is introduced into and discharged from the container C at the same time.

5. The extraction process according to claim 1, wherein at least a portion of the carrier is provided by a solid phase carrier and at least a portion of the solvent is provided by a water containing solvent.

6. The extraction process according to claim 1 which is carried out at an overpressure in the container C of 2-100 bar.

7. The extraction process according to claim 1 which is carried out at a temperature in the container C of 40-120° C.

8. The extraction process according to claim 1 wherein the carrier contains coffee.

9. The extraction process according to claim 1 wherein the container C is provided by a (closed) beverage-brewing container.

10. The extraction process according to claim 1 where
at least 25 wt. % of the mixture of the polyester resins is represented by a polyester resin A1 having a Tg higher than 50° C. and
at least 55 wt. % of the mixture of the polyester resins is represented by a polyester resin A2 having a Tg below 25° C.

11. The extraction process according to claim 1 where
at least 60 wt. % of the polyester resin A1 has a Tg of 57-95° C. and at least 60 wt. % of the polyester resin A2 has a Tg of 2-24° C.

12. The extraction process according to claim 1 wherein 90 wt. % of the polyester resin A1 has an acid value of <10 mg KOH/g (according to DIN EN ISO 2114) and a hydroxyl value of 2-20 mg KOH/g (according to DIN EN ISO 4629-2).

13. The extraction process according to claim 1 where 90 wt. % of the polyester resin A2 has an acid value of <15 mg KOH/g and a hydroxyl value of <15 mg KOH/g.

14. The extraction process according to claim 1 where the coating composition comprises 75-100 wt. % of the mixture of polyester resins.

15. The extraction process according to claim 1 where the coating composition further comprises a mineral filler and/or a wax.

16. The extraction process according to claim 1 where the coating composition contains less than 1 wt. % polyvinylchloride.

17. The extraction process according to claim 1 where the coating composition contains less than 4.0 wt. % crosslinking resin.

18. The extraction process according to claim 1 where coating composition contains less than 4.0 wt. % crosslinking resin selected from the group consisting of urea-formaldehyde resins, melamine-formaldehyde resins, benzoguanamine-formaldehyde resins and glycoluril-formaldehyde resins.

19. The extraction process according to claim 1 where the heat-sealed seam provides a sealing-seam strength of more than 12 N/15 mm, (according to a modified DIN 55529, 2012 edition—modifications: trigger angle is 180°, testing speed is 200 mm/min).

20. The extraction process according to claim 1 where the lidding foil and the body defining the receiving space are each provided by a metal or a metal alloy.

21. The extraction process according to claim 1 where the body has a flange extending from its jacket wall, where the heat-sealed seam lies on said flange.

22. The extraction process according to claim 1 where the inner surface of the body is completely coated with the heat-seal lacquer and where said heat-seal lacquer coating preferably has a thickness of 6-17 g/m².

23. (canceled)
